(19) United States
(12) Patent Application Publication
(10) Pub. No.: US 2026/0070286 A1
(43) Pub. Date: Mar. 12, 2026

(54) THREE DIMENSIONAL MOLDING DEVICE

(71) Applicant: SEIKO EPSON CORPORATION, Tokyo (JP)

(72) Inventors: Kohei ADACHI, SUWA-SHI (JP); Atsushi MAJIMA, ASAHI-MURA (JP)

(21) Appl. No.: 19/321,420

(22) Filed: Sep. 8, 2025

(30) Foreign Application Priority Data
Sep. 9, 2024 (JP) 2024-154722

(51) Int. Cl. B29C 64/393; B29C 64/295; B29C 64/321; B29C 64/35; B33Y 30/00; B33Y 50/02

(52) U.S. Cl. CPC B29C 64/393; B29C 64/295; B29C 64/321; B29C 64/35; B33Y 30/00; B33Y 50/02

(57) ABSTRACT

A control section executes a heating process of applying heat to a plasticizing section to plasticize raw material, a standby process in which the plasticizing section stands by for a certain period of time after reaching a command temperature by the heating process, an opening process of opening an ejection amount adjustment section after the standby process, and a detection process of detecting a torque value applied to the ejection amount adjustment section after the opening process.

The present application is based on, and claims priority from JP Application Serial Number 2024-154722, filed Sep. 9, 2024, the disclosure of which is hereby incorporated by reference herein in its entirety.

### BACKGROUND

### 1. Technical Field

The present disclosure relates to a three dimensional molding device.

### 2. Related Art

JP-A-2024-082771 discloses a configuration of a three dimensional molding device including a plasticizing section that plasticizes a supplied material to generate a molding material in a paste form having fluidity and guides the molding material to an ejection section. The plasticizing section includes a screw and a drive motor that rotates the screw. When the molding is started in a state where the material is not completely melted, a load is applied to the drive motor and the three dimensional molding device stops, and thus it is necessary to confirm whether the material is completely melted before the molding is started.

However, in the configuration described in JP-A-2024-082771, it is necessary to check whether the material is completely melted before the start of molding, and thus there is a problem that the configuration is a burden on the user.

### SUMMARY

A three dimensional molding device includes a plasticizing section configured to plasticize a material by heat to generate a plasticized material; a nozzle that ejects the plasticized material; a table on which the plasticized material ejected from the nozzle is deposited; a position change section configured to change a relative position between the nozzle and the table; an ejection amount adjustment section that communicates with the nozzle, that is provided in a flow path through which the plasticized material flows, and that adjusts the ejection amount of the plasticized material from the nozzle by adjusting an opening area of the flow path; and a control section configured to control the plasticizing section, the position change section, and the ejection amount adjustment section to mold a three dimensional molded object in a molding region of the table, wherein the control section executes a heating process of applying heat to the plasticizing section to plasticize the material, a standby process in which the plasticizing section stands by for a certain period of time after reaching a command temperature by the heating process, an opening process of opening the ejection amount adjustment section after the standby process, and a detection process of detecting a torque value applied to the ejection amount adjustment section after the opening process.

### BRIEF DESCRIPTION OF THE DRAWINGS

FIG. 1 is a cross-sectional view showing a configuration of a three dimensional molding device.

FIG. 2 is a perspective view showing a configuration of a flat screw.

FIG. 3 is a plan view showing the configuration of a barrel.

FIG. 4 is a flowchart showing plasticization confirmation process.

FIG. 5 is a flowchart showing a plasticization confirmation process according to a modification.

### DESCRIPTION OF EMBODIMENTS

Hereinafter, a configuration of the three dimensional molding device 1000 will be described with reference to the drawings. In the following drawings, three axes orthogonal to each other are described as a X axis, a Y axis, and a Z axis. A direction along the X axis is defined as an “X direction”, a direction along the Y axis is defined as a “Y direction”, a direction along the Z axis is defined as a “Z direction”, a direction of an arrow is defined as a +direction, and a direction opposite to the +direction is defined as a −direction. Note that viewing from the +Z direction or the −Z direction is also referred to as plan view or planar.

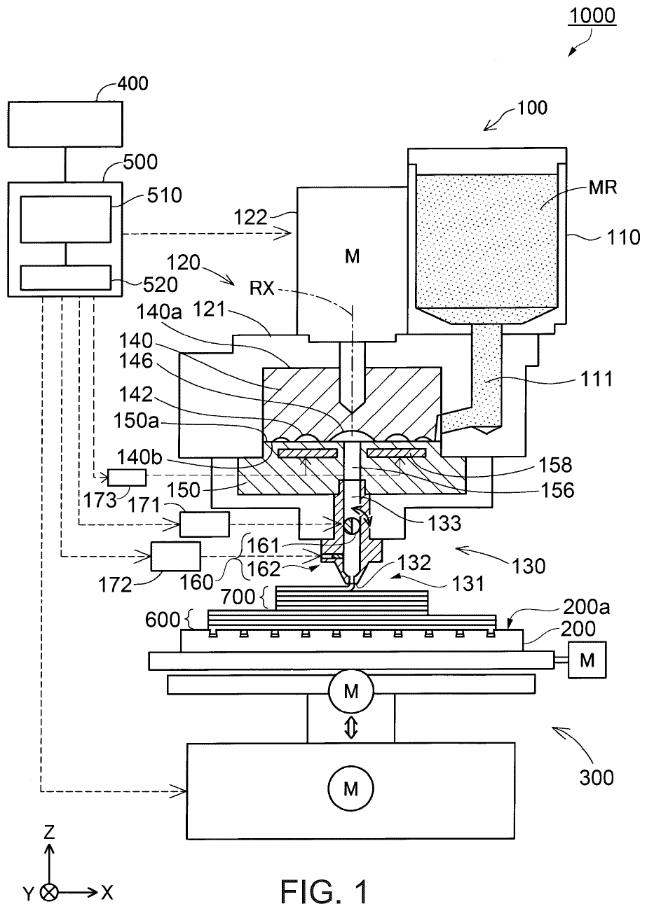

First, a configuration of a three dimensional molding device 1000 will be described with reference to FIG. 1.

As illustrated in FIG. 1, the three dimensional molding device 1000 is a device that molds molded object 700 as a three dimensional molded object by a material extrusion method. The three dimensional molding device 1000 includes a molding section 100 that generates and ejects a plasticized material, a molding table 200 serving as a base of a molded object 700, a position change section 300 that controls an ejection position of the plasticized material, an information processing device 400, and a control section 500 that controls each section of the three dimensional molding device 1000.

The molding section 100 ejects a plasticized material obtained by plasticizing a material in a solid state toward the table 200 under the control of the control section 500. The molding section 100 includes a material supply section 110 which is a supply source of a raw material as a material before being converted into a plasticized material, a plasticizing section 120 which converts the raw material into the plasticized material, and an ejection section 130 which ejects the plasticized material.

The material supply section 110 supplies raw material MR to the plasticizing section 120. The material supply section 110 is constituted by, for example, a hopper that accommodates the raw material MR. The material supply section 110 is connected to the plasticizing section 120 via a communication path 111. The raw material MR is supplied to the material supply section 110 in the form of pellets, powder, or the like.

The plasticizing section 120 plasticizes the raw material MR supplied from the material supply section 110 to generate a pasty plasticized material exhibiting fluidity, and guides the plasticized material to the ejection section 130. In the present embodiment, the term “plasticization” is a concept that includes melting, and is a change from a solid state to a state having fluidity.

Specifically, in the case of a material in which glass transition occurs, plasticization means that the temperature of the material is set to be equal to or higher than the glass transition point. In the case of a material in which glass transition does not occur, plasticization means that the temperature of the material is raised to higher than the melting point. As the material to be plasticized, a material containing a crystalline resin or an amorphous resin can be used. In the present embodiment, the material to be plasticized includes a crystalline resin. Therefore, as the raw material MR, for example, a resin such as polyethylene, polypropylene, POM, or PEEK is used.

The plasticizing section 120 includes a screw case 121, a motor 122, a flat screw 140, and a barrel 150. The flat screw 140 is also referred to as a rotor or scroll. The barrel 150 is also called a screw facing section.

The flat screw 140 is housed in the screw case 121. The upper surface 140a of the flat screw 140 is connected to a motor 122. The flat screw 140 is rotated in the screw case 121 by a rotational driving force generated by the motor 122. The motor 122 is driven under the control of the control section 500. The flat screw 140 may be driven by the motor 122 via a speed reducer.

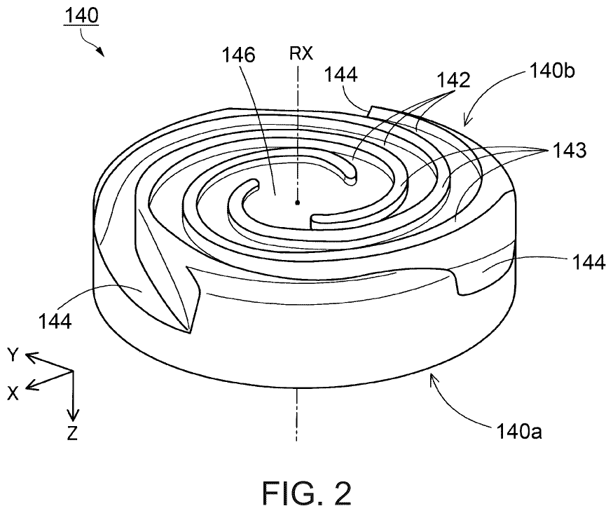

The lower surface 140b of the flat screw 140 faces the upper surface 150a of the barrel 150. In the lower surface 140b of the flat screw 140, a space is formed between the groove section 142 and the upper surface 150a of the barrel 150. The raw material MR is supplied to the space from the material supply section 110 through a material inlet 144 (refer to FIG. 2).

The barrel heater 158 is embedded in the barrel 150 to heat the raw material MR fed into the groove section 142 of the rotating flat screw 140. A communicating hole 156 is provided at the center of the barrel 150. The barrel heater 158 is driven by the third drive section 173 under the control of the control section 500. The control section 500 can adjust the temperature of the plasticizing section 120 by controlling the temperature of the barrel heater 158 using the third drive section 173.

The ejection section 130 includes a nozzle 131 that ejects the plasticized material, a flow path 133 of the plasticized material provided between the flat screw 140 and a nozzle opening 132, and an ejection control section 160 that controls the ejection of the plasticized material.

The nozzle 131 is connected to the communicating hole 156 of the barrel 150 via the flow path 133. The nozzle 131 ejects the plasticized material generated in the plasticizing section 120 from a nozzle opening 132 at the tip toward the table 200.

The ejection control section 160 includes an ejection amount adjustment section 161 that opens and closes the flow path 133, and a suction section 162 that draws in the plasticized material and temporarily holds the plasticized material. The ejection amount adjustment section 161 is provided in the flow path 133, and changes the opening degree of the flow path 133 by rotating in the flow path 133.

In the present embodiment, the ejection amount adjustment section 161 is configured by a butterfly valve. The ejection amount adjustment section 161 is driven by the first drive section 171 under the control of the control section 500. The first drive section 171 is configured by, for example, a drive motor. The control section 500 can adjust the flow rate of the plasticized material flowing from the plasticizing section 120 to the nozzle 131, that is, the ejection amount of the plasticized material ejected from the nozzle 131, by controlling the rotation angle of the butterfly valve using the first drive section 171. The ejection amount adjustment section 161 can adjust the ejection amount of the plasticized material and can control on/off of the outflow of the plasticized material.

The suction section 162 is connected between the ejection amount adjustment section 161 and the nozzle opening 132 in the flow path 133. The suction section 162 temporarily sucks in the plasticized material in the flow path 133 when ejection of the plasticized material from the nozzle 131 is stopped, thereby suppressing a tailing phenomenon in which the plasticized material drips from the nozzle opening 132 like a thread being pulled.

In the present embodiment, the suction section 162 is constituted by a plunger. The suction section 162 is driven by a second drive section 172 under the control of the control section 500. The second drive section 172 is constituted by, for example, a stepping motor and a rack and pinion mechanism that converts the rotational force of the stepping motor into the translational movement of the plunger.

The table 200 is disposed at a position facing the nozzle opening 132 of the nozzle 131. The table 200 is disposed so as to be parallel to the X and Y directions, that is, the horizontal directions. The table 200 has a molding surface 200a where the molded object 700 is molded.

On the table 200, for example, a sacrificial layer 600 for forming a molded object 700 is formed. The molded object 700 is formed on the sacrificial layer 600.

The position change section 300 changes the relative position between the table 200 and the nozzle 131 under the control of the control section 500. In the present embodiment, the position of the nozzle 131 is fixed, and the position change section 300 moves the table 200. The position change section 300 is configured by a three axis positioner that moves the table 200 in three axial directions of the X, Y, and Z directions by driving forces of three motors.

The control section 500 is a control device that controls operation of the entire three dimensional molding device 1000. The control section 500 is configured by a computer including one or a plurality of processors 510, a storage device 520 including a main storage device and an auxiliary storage device, and an input/output interface that inputs and outputs signals from and to outside. The control section 500 and the information processing device 400 are communicably coupled to each other.

The processor 510 controls the molding section 100 and the position change section 300 according to molding data acquired from the information processing device 400 by executing the program stored in the storage device 520, and molds the molded object 700 on the table 200. Note that the control section 500 may be realized by a configuration of a combination of circuits, instead of being configured by a computer.

Next, the configuration of the flat screw 140 will be described with reference to FIG. 2.

The flat screw 140 shown in FIG. 2 is shown in a state where the positional relationship between the upper surface 140a and the lower surface 140b shown in FIG. 1 is reversed in the vertical direction. The flat screw 140 has a substantially cylindrical shape with a length in an axial direction, which is a direction along its central axis, is smaller than its length in a direction perpendicular to the axial direction. The flat screw 140 is disposed so that a rotation axis RX, which is the center of rotation, is parallel to the Z direction.

A spiral groove section 142 is formed in a lower surface 140b of the flat screw 140, which is a surface intersecting the rotational axis RX. The communication path 111 of the material supply section 110 communicates with the groove section 142 from the side surface of the flat screw 140. In the present embodiment, the groove section 142 is formed into three sections separated by the convex section 143. Note that the number of groove sections 142 is not limited to three, and may be one or two or more. The groove sections 142 are not limited to a vortex shape, may be helical or involute curvilinear, and may extend so as to draw an arc from the central section to the outer periphery.

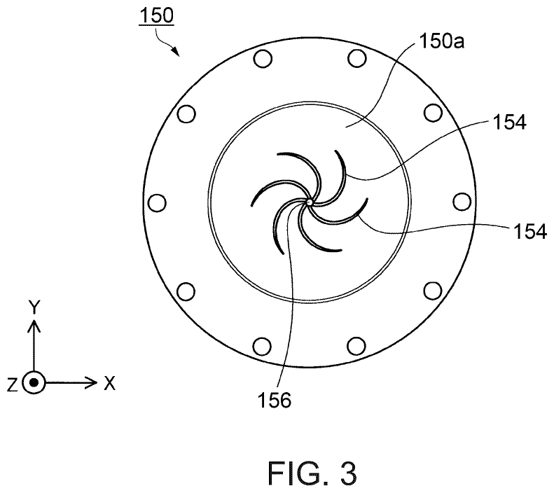

Next, the configuration of the barrel 150 will be described with reference to FIG. 3.

As shown in FIG. 3, a plurality of guide grooves 154 that are connected to the communicating hole 156 and that extend in a spiral shape from the communicating hole 156 toward the outer periphery are formed in the upper surface 150a of the barrel 150. One end of the guide groove 154 may not be connected to the communicating hole 156. It is also possible to omit the guide groove 154.

The raw material MR supplied into the groove section 142 of the flat screw 140 flows along the groove section 142 by rotation of the flat screw 140 while being plasticized in the groove section 142, and is guided to the central section 146 of the flat screw 140 as a plasticized material. The pasty plasticized material exhibiting fluidity, which has flowed into the central section 146, is supplied to the ejection section 130 via the communicating hole 156 provided at the center of the barrel 150.

Note that in the plasticized material, all the substances constituting the plasticized material may not be plasticized. It is sufficient that the plasticized material is converted into a state having fluidity as a whole by plasticizing at least some kinds of substances among the substances constituting the plasticized material.

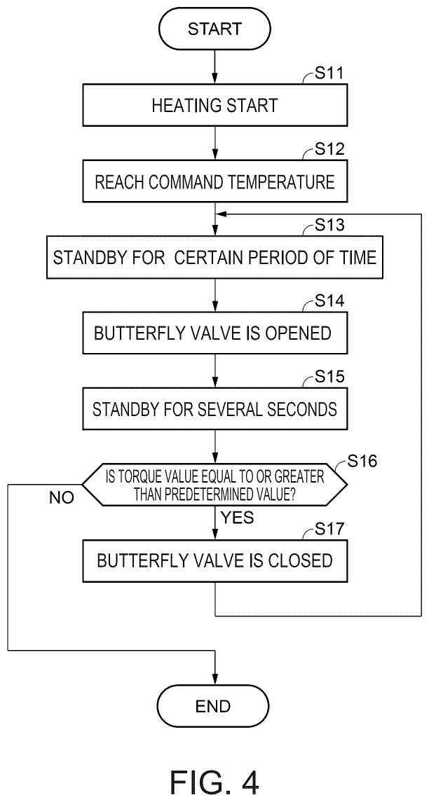

Next, a plasticization confirmation process of the three dimensional molding device 1000 will be described with reference to FIG. 4.

First, as shown in FIG. 4, in step S11, the heating process is started (heating process). Specifically, the control section 500 controls the third drive section 173 to increase the temperature of the barrel heater 158, that is, the temperature of the plasticizing section 120. As a result, the raw material MR is heated and melted, that is, plasticization proceeds.

In step S12, the temperature of the plasticizing section 120 reaches a command temperature. Specifically, the control section 500 controls the third drive section 173 to stop increasing the temperature of the barrel heater 158.

In step S13, standby is performed for a certain period of time (standby process). A standby for a certain period of time is a period of time until the raw material MR is melted, and specifically, is, for example, about one minute.

In step S14, the butterfly valve is opened (opening process). Specifically, the control section 500 controls the first drive section 171 to open the butterfly valve, that is, the ejection amount adjustment section 161. At step S15, a standby is performed for several seconds. That is, the ejection amount adjustment section 161 is kept open. The standby time is, for example, about 1 second to 2 seconds.

In step S16, it is determined whether or not the torque value is equal to or greater than a certain value, that is, equal to or greater than a specified value (detection process). Specifically, the control section 500 causes a detection section (not shown) to detect a torque value of a drive motor that drives the butterfly valve. Next, the control section 500 causes a determination section (not shown) to determine whether or not the torque value is equal to or greater than a certain value.

When the amount of the raw material MR is equal to or greater than the certain value, that is, when it is determined that the raw material MR is not completely melted, in other words, the butterfly valve is clogged with the raw material MR, the process proceeds to step S17. When the difference is not equal to or greater than the certain value, that is, when it is determined that the raw material MR is completely melted, the plasticization confirmation process is ended. That is, the nozzle 131 is in a state where the plasticized material can be ejected from the nozzle 102, in other words, in a molding start state.

In step S17, the butterfly valve is closed. Specifically, the control section 500 controls the first drive section 171 to stop opening the butterfly valve, that is, the ejection amount adjustment section 161. Thereafter, in step S16, the processing from step S13 to step S17 is repeated until the torque value becomes equal to or less than a predetermined value, that is, until the raw material MR is completely melted.

In this manner, since the torque value of the drive motor that drives the butterfly valve is detected by the detection process, it is possible to easily know whether the raw material MR is completely melted before the molding is started by comparing the torque values. Therefore, since the user does not need to directly check the dissolution degree of the raw material MR, it is possible to suppress the burden on the user.

In a case where the torque value is equal to or greater than the specified value, that is, in a case where the raw material MR is not completely melted, the process is repeated until the raw material MR is completely melted, and thus, it is possible to proceed to the state of the start of molding without the user checking each time.

As described above, in a case where the raw material MR is not completely melted, the process is not limited to being repeated until the raw material MR is completely melted, and in a case where the process is repeated a certain number of times, all the processes may be terminated, that is, the operation of the three dimensional molding device 1000 may be stopped.

Specifically, it is desirable that the control section 500 repeats the standby process, the opening process, and the detection process a number of times, and stops all processes when the number of times exceeds a certain number of times. The certain number of times is, for example, about five times. The time for five times is, for example, about five minutes. According to this configuration, since all the processes are stopped when the number of times exceeds the certain number of times, that is, the processes are stopped when it is determined that the raw material MR is not completely melted, the user can execute the next process early.

As described above, the three dimensional molding device 1000 of the present embodiment includes: a plasticizing section 120 configured to plasticize a raw material MR by heat to generate a plasticized material; a nozzle 131 that ejects the plasticized material; a table 200 on which the plasticized material ejected from the nozzle 131 is deposited; a position change section 300 configured to change a relative position between the nozzle 131 and the table 200; an ejection amount adjustment section 161 that communicates with the nozzle 131, that is provided in the flow path 133 through which the plasticized material flows, and that adjusts the ejection amount of the plasticized material from the nozzle 131 by adjusting an opening area of the flow path 133; and a control section 500 configured to control the plasticizing section 120, the position change section 300, and the ejection amount adjustment section 161 to mold the molded object 700 in the molding region of the table 200, wherein the control section 500 executes a heating process of applying heat to the plasticizing section 120 to plasticize the raw material MR, a standby process in which the plasticizing section 120 stands by for a certain period of time after reaching the command temperature by the heating process, and an opening process of opening the ejection amount adjustment section 161 after the standby process, and a detection process of detecting a torque value applied to the ejection amount adjustment section 161 after the opening process.

According to this configuration, since the torque value is detected by the detection process, it is possible, based on the torque value, to easily know whether the raw material MR is completely melted before molding is started. Therefore, since the user does not need to directly check the dissolution degree of the raw material MR, it is possible to suppress the burden on the user. It is possible to prevent molding from being stopped due to overload of the drive motor, as in a case where the molding is started in a state where the raw material MR is not completely melted.

In the three dimensional molding device 1000 of the present embodiment, it is desirable that the control section 500 closes the flow path 133 by the ejection amount adjustment section 161 and executes the standby process when the torque value detected by the detection process is equal to or greater than a specified value. According to this configuration, when the torque value is equal to or greater than the specified value, that is, when the raw material MR is not completely melted, the standby process is executed, and thus, the temperature can be brought nearer to the command temperature. That is, the raw material MR can be further melted.

In the three dimensional molding device 1000 of the present embodiment, it is desirable that the control section 500 executes the opening process and the detection process again after the standby process, and executes the standby process, the opening process, and the detection process until the torque value becomes equal to or less than the specified value. According to this configuration, since the above process is executed until the torque value becomes equal to or less than the specified value and the torque value is detected each time, it is possible to melt the raw material MR more.

In the three dimensional molding device 1000 of the present embodiment, it is desirable that the control section 500 repeats the standby process, the opening process, and the detection process a number of times, and stops all the processes when the number of times exceeds a certain number of times. According to this configuration, since all the processes are stopped when the number of times exceeds the certain number of times, that is, the processes are stopped when it is determined that the raw material MR is not completely melted, the user can execute the next process early.

Hereinafter, a modification of the above-described embodiment will be described.

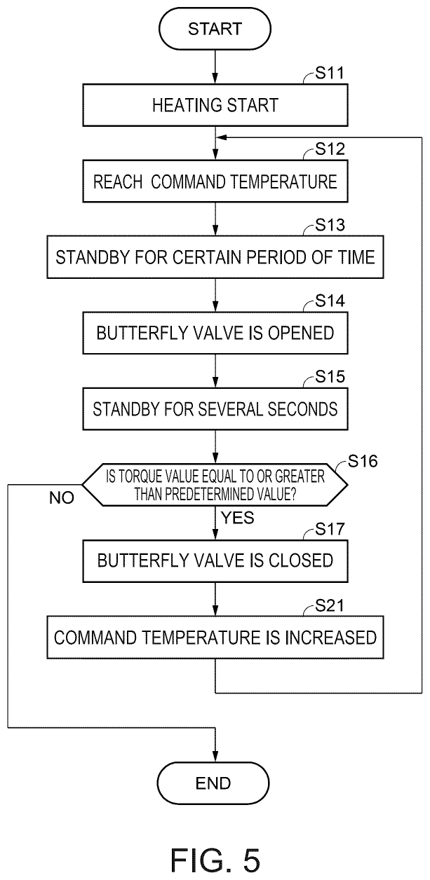

As described above, when the material MR is not completely melted, the process is not limited to standby for a certain period of time in step S13, and as shown in FIG. 5, the process may standby for a certain period of time in step S13 after the command temperature is increased. As shown in FIG. 5, the plasticization confirmation process of the modification is the same as that of the above-described embodiment in steps S11 to S17. The portion in which step S17 is performed after step S21 and then the process returns to step S12 is different from the above embodiment.

In particular, in step S17, the material MR is not completely melted, and after the butterfly valve is closed, the command temperature is increased in step S21 (temperature change process). The control section 500 controls the third drive section 173 to increase the temperature of the barrel heater 158, that is, the temperature of the plasticizing section 120. Thereafter, the process returns to step S12, and a predetermined process is performed. In this way, when the raw material MR is not completely melted, the command temperature is increased, and thus, the raw material MR can be melted more quickly.

In the plasticization confirmation process of the modification, it is desirable to repeat steps S12 to S17 until the torque becomes equal to or less than the specified value in the same manner as in the above embodiment. It is desirable to stop all the processes when the number of repetitions exceeds a certain number of times, that is, to stop the processes when it is determined that the raw material MR is not completely melted. Therefore, the user can cause the next process to be executed at an early stage.

As described above, in the three dimensional molding device 1000 of the modification, when the torque value detected by the detection process is equal to or greater than the specified value, the control section 500 desirably closes the flow path 133 by using the ejection amount adjustment section 161 and executes the temperature change process of increasing the command temperature. According to this configuration, when the torque value is equal to or greater than the specified value, that is, when the raw material MR is not completely melted, the command temperature is increased, and thus, the raw material MR can be further melted.

In the three dimensional molding device 1000 of the modification, the control section 500 desirably executes a standby process after the temperature change process. According to this configuration, since the standby process is executed after the temperature change process, the temperature can be brought closer to the increased command temperature. That is, the raw material MR can be further melted.

In three dimensional molding device 1000 of the modification, it is desirable that the control section 500 executes the opening process and the detection process again after the standby process, and executes the temperature change process, the standby process, the opening process, and the detection process until the torque value becomes equal to or less than the specified value. According to this configuration, since the process is performed until the torque value becomes equal to or less than the specified value, the raw material MR can be melted more than the current state.

It is desirable that in the three dimensional molding device 1000 of the modification, the control section 500 repeats the temperature change process, the standby process, the opening process, and the detection process a number of times, and stops all the processes when the number of times exceeds a certain number of times. According to this configuration, since all the processes are stopped when the number of times exceeds the certain number of times, that is, the processes are stopped when it is determined that the raw material MR is not completely melted, the user can execute the next process early.

In addition, in step S16, in a case where it is determined that the raw material MR is completely melted, the plasticization confirmation process is ended, but it is desirable to perform a cleaning process before the start of shaping. Specifically, first, the butterfly valve is closed. Thereafter, the cleaning process is performed, and the molding of the molded object 700 is started. In the cleaning process, foreign matter adhering to the tip end portion is removed by bringing a cleaning member into contact with the tip end portion of the nozzle 131 in a state where the nozzle 131 is separated from and above the table 200. Examples of the cleaning member include a brush, a wiper, and a blade.

As described above, since the cleaning process is performed before the molded object 700 is molded, the three dimensional molded object can be molded in a state where the nozzle 131 is clean. Therefore, the molded object 700 having high molding quality can be molded.

As described above, in the three dimensional molding device 1000 of the modification, when the torque value detected by the detection process is equal to or less than the specified value, the control section 500 desirably closes the flow path 133 by the ejection amount adjustment section 161, performs the cleaning process, and starts molding of the molded object 700. According to this configuration, since the cleaning process is performed before the molded object 700 is molded, the molded object 700 can be molded in a state where the nozzle 131 is clean. Therefore, the molded object 700 having high molding quality can be molded.

What is claimed is:

1. A three dimensional molding device comprising:
a plasticizing section configured to plasticize a material by heat to generate a plasticized material;
a nozzle that ejects the plasticized material;
a table on which the plasticized material ejected from the nozzle is deposited;
a position change section configured to change a relative position between the nozzle and the table;
an ejection amount adjustment section that communicates with the nozzle, that is provided in a flow path through which the plasticized material flows, and that adjusts the ejection amount of the plasticized material from the nozzle by adjusting an opening area of the flow path; and
a control section configured to control the plasticizing section, the position change section, and the ejection amount adjustment section to mold a three dimensional molded object in a molding region of the table, wherein
the control section executes
a heating process of applying heat to the plasticizing section to plasticize the material,
a standby process in which the plasticizing section stands by for a certain period of time after reaching a command temperature by the heating process,
an opening process of opening the ejection amount adjustment section after the standby process, and
a detection process of detecting a torque value applied to the ejection amount adjustment section after the opening process.

2. The three dimensional molding device according to claim 1, wherein
when the torque value detected by the detection process is equal to or greater than a specified value, the control section closes the flow path by using the ejection amount adjustment section and executes the standby process.

3. The three dimensional molding device according to claim 2, wherein
after the standby process, the control section again executes the opening process and the detection process, and executes the standby process, the opening process, and the detection process until the torque value becomes equal to or less than the specified value.

4. The three dimensional molding device according to claim 3, wherein
the control section repeats the standby process, the opening process, and the detection process a number of times, and stops all the processes when the number of times exceeds a certain number of times.

5. The three dimensional molding device according to claim 1, wherein
when the torque value detected by the detection process is equal to or greater than a specified value, the control section executes a temperature change process to close the flow path by using the ejection amount adjustment section and to raise the command temperature.

6. The three dimensional molding device according to claim 5, wherein
the control section executes the standby process after the temperature change process.

7. The three dimensional molding device according to claim 6, wherein
after the standby process, the control section executes the opening process and the detection process again and executes the temperature change process, the standby process, the opening process, and the detection process until the torque value becomes equal to or less than the specified value.

8. The three dimensional molding device according to claim 7, wherein
the control section repeats the temperature change process, the standby process, the opening process, and the detection process a number of times, and stops all the processes when the number of times exceeds a certain number of times.

9. The three dimensional molding device according to claim 1, wherein
when the torque value detected by the detection process is equal to or less than a specified value, the control section closes the flow path by using the ejection amount adjustment section, performs a cleaning process, and starts molding of the three dimensional molded object.
